(19) United States
(12) Patent Application Publication
(10) Pub. No.: US 2007/0037707 A1
(43) Pub. Date: Feb. 15, 2007

(54) Plant growth regulator formulations

(75) Inventors: Gregory C. Volgas, Bartlett, TN (US); Trey Baker, Horn Lake, MS (US); Johnnie R. Roberts, Arlington, TN (US)

Correspondence Address: Connolly Bove Lodge & Hutz LLP, 1007 North Orange Street, P.O. Box 2207, Wilmington, DE, 19899, US

(73) Assignee: HELENA HOLDING COMPANY, Wilmington, DE (US)

(21) Appl. No.: 11/502,902

(22) Filed: Aug. 11, 2006

Related U.S. Application Data
(60) Provisional application No. 60/707,478, filed on Aug. 11, 2005.

(51) Int. Cl. A01N 57/00

(52) U.S. Cl. 504/194

(57) ABSTRACT

An agricultural composition containing a. (2-chloroethyl)phosphonic acid, and b. an organic acid or a phosphorus containing acid and with the proviso that said composition contains essentially no or no cyclanilide.

### RELATED APPLICATIONS

This application claims benefit to Provisional Application Ser. No. 60/707,478 filed Aug. 11, 2005 which is incorporated by reference in its entirety for all useful purposes.

### BACKGROUND OF THE INVENTION

Plant growth regulators have been used to control the growth of cotton after the plant has produced bolls. Plant growth regulators have also been to induce the opening of cotton bolls prior to harvest.

(2-chloroethyl)phosphonic acid is one such plant growth regulator with systemic properties. It penetrates into the plant tissues, and is decomposed to ethylene, which affects the growth processes. (2-chloroethyl)phosphonic acid is sold under the commercial names Ethrel and Cerone. (2-chloroethyl)phosphonic acid is water soluble.

Acidic adjuvants have commonly been used as pH modifiers or buffers for agricultural pesticide applications. Commonly used acids are citric and phosphoric acids, as well as esters of phosphoric acid such as nonylphenol ethoxylate phosphate esters and alcohol ethoxylate phosphate esters.

These acids are used to modify the pH of spray solutions and are added separately to the spray solution by the applicator. Reduced pH can improve uptake of herbicides. Glyphosate is one herbicide which is known to have improved uptake at lower pH ranges. Acids have also been used to prevent alkaline hydrolysis of some pesticides. Organophosphates, such as dimethoate, can break down significantly at pH ranges above neutral. There effective life can be extended by lowering the pH of the spray solution to below 7.0.

One such acidic adjuvant that has been applied with positive effect with (2-chloroethyl) phosphonic acid is called LI-700. LI-700 contains predominantly propionic acid and surfactants. LI-700 has been sold as an adjuvant or additive, and can not be reliably co-formulated with (2-chloroethyl)phosphonic acid.

Another such adjuvant that has been applied with positive effect with (2-chloroethyl) phosphonic acid contains both citric and phosphoric acid. This adjuvant has only been sold as a tank mix additive for (2-chloroethyl) phosphonic acid.

There are numerous advantages to formulating pesticides with the adjuvant built in. Growers typically do not like to add separate ingredients to enhance pesticide efficacy. By adding the adjuvant directly into the pesticide formulation, formulators can lock in the application rate of both the pesticide and adjuvant.

There are potential disadvantages to formulating pesticides with the adjuvant built in. In the case of many adjuvants, the best use rate is highly dependent on the water volume used for application. However, the rate of pesticide used is based on a volume per acre. Since per acre application volumes of pesticides varies greatly from one grower to the next, some built-in adjuvants may not be applied at their most efficacious use rate on a volume to volume basis.

U.S. Pat. No. 4,397,675 (Young) discloses the combination of urea and sulfuric acid and subsequent patents disclose the use of these reaction products as spray adjuvants to enhance pesticide efficacy. U.S. Pat. No. 5,541,149 (Atwater) discloses the use of the Young spray adjuvant in combination with (2-chloroethyl)phosphonic acid. In fact, one product marketed as CottonQuick by Dupont in the USA, blends the adjuvant containing urea and sulfuric acid, into a formulation containing (2-chloroethyl) phosphonic acid. The disadvantage of this formulation is the extreme corrositivity of sulfuric acid on metal.

U.S. Pat. No. 6,551,964 (Bardsley et.al.) discloses the use of citric acid derivatives as agricultural adjuvants. These derivatives are not of a concern to this invention, rather citric acid alone.

(2-chloroethyl) phosphonic acid is formulated at low pH ranges and when mixed with water, has a strongly acidic pH. The pH of the pure product, according to the MSDS sheet for a formulated product, is 1.7. (2-chloroethyl)phosphonic acid is stable at pH ranges below 3.5. At higher pH ranges, it has been reported to decompose and liberate ethylene, according to the Tenth Edition of The Pesticide Manual of the British Crop Protection Council. Since commercial formulations are so acidic in their own right, it is unexpected that further reduction of the formulation should enhance activity or reduce decomposition.

Citric acid has been used alone as a cotton defoliant in organically grown cotton. It is not as effective as more conventional cotton defoliation chemistry like (2-chloroethyl) phosphonic acid.

The formulated product FINISH® 6 Pro from Bayer CropScience contains an undisclosed amount of citric acid in conjunction with (2-chloroethyl)phosphonic acid and cyclanilide. According to the MSDS cyclanilide is present in an amount 3.3000 percent by weight based on the total weight of the composition. It is noted that on the MSDS sheet FINISH® brand 6 Harverst aid for cotton from Bayer CropScience has 6.4% cyclanilide. Cyclanilide is not necessary in the current invention. The current invention can be practiced with or without cyclanide. Cyclanilide is not soluble in the formulation and the product is therefore formulated as a liquid flowable (a suspension of solid particles in a liquid). Liquid flowable formulations are not stable over long periods of time, as the suspended particles settle to the bottom of containers. In fact, commercial containers of Finish 6 Pro include a “Shake Well” sticker in an effort to address this problem.

U.S. patent application Ser. No. 10/728,419 (Parrish) discloses a composition formed by mixing (a) an acid with (b) phosphonic compounds. Acids in group (a) include, but are not limited to: hydrochloric, muratic, nitric, phosphoric, phosphorous, poly phosphoric, perchloric, citric and acetic acids. Phosphonic compounds in group (b) are selected from but not limited by the group consisting of (2-chloroethyl)phosphonic acid and salts of (2-chloroethyl)phosphonic acid. However, the application fails to limit the acids and even includes what was disclosed in the prior art, U.S. Pat. No. 5,541,149 (Atwater). Furthermore, the patent shows no exemplary art using anything but muratic acid. It does however disclose a preferred composition containing 2-chlorophosphonic acid 10%-20% and Phosphoric Acid 1%-40%. The example shown in this application fails to allow calculation of the ratio of muratic acid to (2-chloroethyl) phosphonic acid. It states the use rate of the (2-chloroethyl) phosphonic acid at 16 ounces per acre and then states the use rate of muratic acid as 4% v/v. By failing to disclose the amount of water sprayed per acre, it is impossible to calculate the ratio of the two acids.

### SUMMARY OF THE INVENTION

It has been surprisingly been discovered that the addition of phosphorus containing acids and organic acids can enhance the boll opening effects of (2-chloroethyl) phosphonic acid. Such formulations produce clear liquid solutions that are chemically and physically stable. Specifically, the phosphorus containing acids are phosphorous acid and phosphoric acid, but other phosphorus acids should also be effective. The organic acids are carboxylic acids, or more specifically, citric acid. Other organic acids should also be effective.

The formulation preferably contains essentially no or no cyclanilide. Essentially no cyclanidide would be an amount less than FINISH® Pro, which would be less than 3.3% by weight, preferably less than 3% by weight, preferably less than 2% by weight and more preferably less than 1% by weight based on the total weight and most preferably there would be 0% by weight.

The phosphorus containing acids of the present invention include, but are not limited to

Phosphorous acid or

Phosphoric acid.

The organic acids of the present invention include, but are not limited to:

A monocarboxylic acid,

A dicarboxylic acid,

A tricarboxylic acid,

Formic acid,

Acetic acid,

Propionic acid,

Butyric acid,

Valeric acid,

Malonic acid,

Succinic acid,

Glutaric acid or

Citric acid.

The composition may optionally contain at least one surfactant capable of reducing the surface tension of dilute solutions of the formulation. Typically, use of the formulation will require dilution of from 32-96 ounces of the (2-chloroethyl)phosphonic acid formulation into 2-100 gallons of water.

The composition will contain between 5% and 70% of (2-chloroethyl)phosphonic acid before being diluted for use in a spray rig.

The amount of either organic or phosphorus containing acid in the formulation will be between 1 and 95% of the formulation of (2-chloroethyl)phosphonic acid, or preferably between 5 and 80%, or more preferably between 10 and 40% or the formulation.

The examples below are provided to demonstrate possible embodiments of this new formulation technology.

### EXAMPLE 1

| | |
|---|---|
| (2-chloroethyl)phosphonic acid. | 21.7% by weight |
| Citric acid | 33.3% by weight |
| Water | 45.0% by weight |

### EXAMPLE 2

| | |
|---|---|
| (2-chloroethyl)phosphonic acid. | 21.7% by weight |
| Phosphoric acid (85%) | 70.0% by weight |
| Water | 8.3% by weight |

### EXAMPLE 3

| | |
|---|---|
| (2-chloroethyl)phosphonic acid | 29.0% by weight |
| Citric acid | 30.0% by weight |
| Water | 41.0% by weight |

### EXAMPLE 4

| | |
|---|---|
| (2-chloroethyl)phosphonic acid. | 21.7% by weight |
| Phosphorous acid (90%) | 70.0% by weight |
| Water | 8.3% by weight |

### EXAMPLE 5

| | |
|---|---|
| (2-chloroethyl)phosphonic acid. | 23.9% by weight |
| Citric acid | 50.0% by weight |
| Water | 26.1% by weight |

### EXAMPLE 6

| | |
|---|---|
| (2-chloroethyl)phosphonic acid. | 54.0% by weight |
| Citric acid | 25.0% by weight |
| Water | 21.0% by weight |

These examples formulations are storage stable in cold, heated, and ambient storage.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

We claim:

1. An agricultural composition comprising
a. (2-chloroethyl)phosphonic acid, and
b. an organic acid or a phosphorus containing acid and with the proviso that said composition contains essentially no or no cyclanilide.

2. The composition as claimed in claim 1, wherein the other acid is a phosphorus containing acid.

3. The composition as claimed in claim 2, wherein the phosphorus acid is phosphoric acid.

4. The composition as claimed in claim 2, wherein the phosphorus acid is phosphorous acid.

5. The composition as claimed in claim 1, wherein the other acid is an organic acid.

6. The composition as claimed in claim 5, wherein the organic acid is citric acid.

7. The composition as claimed in claim 5, wherein the organic acid is acetic acid.

8. The composition as claimed in claim 5, wherein the organic acid is propionic acid.

9. A harvest aid in cotton production which comprises the composition as claimed in claim 1.

10. A composition as claimed in claim 1, which further comprises that the composition is mixed with water and optionally other components.

11. The composition as claimed in claim 1, which further comprises a surfactant.

12. The composition as claimed in claim 11 wherein the surfactant reduces the surface tension of water by at least 5 dynes/cm when the surfactant is added to water at 0.10% v/v and measured using the Du Nuoy Ring method.

13. The composition as claimed in claim 1 which comprises
a. at least 20% of (2-chloroethyl) phosphonic acid, and
b. at least 25% of another acid, wherein said acid is an organic acid or a phosphorus containing acid
whereas said composition contains no cyclanilide.

14. A method of harvesting cotton which comprises contacting the cotton with the composition as claimed in claim 1.

15. A method of harvesting cotton which comprises spraying the cotton with the composition as claimed in claim 10.
